(19) United States
(12) Patent Application Publication
(10) Pub. No.: US 2009/0006630 A1
(43) Pub. Date: Jan. 1, 2009

(54) Sip converter

(75) Inventors: Yutaka Tsumori, Koriyama-shi (JP); Motoki Takahashi, Koriyama-shi (JP); Tomohiro Watanabe, Koriyama-shi (JP)

Correspondence Address: KUBOTERA & ASSOCIATES, LLC.;SUITE 202, 200 DAINGERFIELD ROAD, ALEXANDRIA, VA, 22314, US

(73) Assignee: HITACHI COMMUNICATION TECHNOLOGIES, LTD.

(21) Appl. No.: 12/155,990

(22) Filed: Jun. 12, 2008

(30) Foreign Application Priority Data
Jun. 14, 2007 (JP) 2007-157242

(51) Int. Cl. G06F 15/16

(52) U.S. Cl. 709/227

(57) ABSTRACT

When communications are performed by connecting a non-SIP information terminal device in which SIP is not supported to a SIP converter connected to a communication line via a line terminating device, the SIP converter performs establishment and disconnection of a SIP session, and transmission of a SIP message on behalf of the non-SIP information terminal device.

### PRIORITY INFORMATION

This application claims the priority to Japanese Patent Application No. 2007-157242, filed on Jun. 14, 2007, which is incorporated herein by reference in its entirety.

### BACKGROUND

The present invention relates to an SIP converter.

### RELATED ART

Conventionally, when SIP information terminal devices are connected to each other via a communication line, a technology which enables communications between both SIP information terminal devices using signaling repeating installation provided with optional function means which allows for optional functions of shaping, catch phone, and broadcast of packets to be held, transferred, and transmitted between both the communication terminals other than a relay of signaling messages and media data even when a signaling system, an IP address system, or the like is different from each other in both the SIP information terminal devices has been known (Refer to Japanese Unexamined Patent Publication (Kokai) No. 2006-135522).

Hence, the technology constituted as described above is limited to a case of enabling the communications between the SIP information terminals themselves, and when a non-SIP information terminal in which SIP is not supported is connected via the communication line, data communications cannot be performed with a communication partner by utilizing SIP, and thus management of communications utilizing SIP could not be performed, either.

### SUMMARY

Therefore, the present invention is made in view of such points, and it is an object of the invention to provide a SIP converter can perform establishment and disconnection of a SIP session, and transmission of a SIP message on behalf of the non-SIP information terminal device to thereby perform management of communications of the non-SIP terminal device by utilizing SIP, when the non-SIP information terminal device in which SIP is not supported is connected via a communication line.

A SIP converter in accordance with the present invention is connected to a communication line via a line terminating device, and when communications are performed by connecting a non-SIP information terminal device, the SIP converter can perform establishment and disconnection of a SIP session, and transmission of a SIP message on behalf of the non-SIP information terminal device.

Here, the non-SIP information terminal device includes, for example, a digital camera, a digital video camera, a portable audio player, a personal computer, or the like.

According to such a configuration, even when the non-SIP information terminal device is connected to the SIP converter, the SIP converter can perform the establishment and disconnection of the SIP session, and the transmission of the SIP message on behalf of the non-SIP information terminal device to thereby perform management of communications of the non-SIP information terminal device by utilizing SIP.

Moreover, the SIP converter in accordance with the present invention may be constituted by including, in the SIP converter in the aforementioned invention, a terminal interface section for transmitting and receiving data with the non-SIP information terminal device; a SIP session processing section for performing establishment and disconnection of the SIP session, and transmission of the SIP message with a communication partner connected via the communication line; a data converting unit for generating the SIP message and performing a conversion between the non-SIP information and the SIP message; a configuration information storage section for setting up an established destination, establishment conditions, and disconnection conditions of the SIP session, and a transmission destination and transmission conditions of the SIP message; and a control section for controlling the terminal interface section, the data converting section, the SIP session control section, and the configuration information storage section.

According to such a configuration, when the non-SIP information terminal device is connected to the SIP converter, the SIP session is established by a trigger given from the non-SIP information terminal device via the terminal interface section with a communication partner connected via the communication line by the SIP session processing section based on the establishment and establishment conditions of the SIP session stored in the configuration information storage section, and thereafter the SIP session with the communication partner is disconnected based on disconnection information of the SIP session of the configuration information storage section, or the transmitted non-SIP information is converted into the SIP message by the data converting section by a trigger similarly given to transmit the SIP message based on transmission destination information in the configuration information storage section, so that even when the non-SIP information terminal device is connected to the SIP converter, the SIP converter can perform the establishment and disconnection of the SIP session, and the transmission of the SIP message on behalf of the non-SIP information terminal device to thereby perform management of communications of the non-SIP information terminal device by utilizing SIP.

The present invention may be constituted in such a way that, in the above-mentioned invention, the SIP converter is provided with a data buffer section which temporarily stores the received data from the non-SIP information terminal device via the terminal interface section and the received data from the communication partner via the communication line.

According to this configuration, since the data buffer section can temporarily store the received data from the non-SIP information terminal device and the received data from the communication partner via the communication line, communications with the communication partner can be performed efficiently.

Moreover, the present invention may be constituted in such a way that the control section in the aforementioned invention detects a connection of the SIP information terminal device to the terminal interface section, or a power turn-on thereof to thereby make the SIP session processing section establish the SIP session, and detects a disconnection of the non-SIP information terminal device from the terminal interface section, or a power turn-off thereof to thereby make the SIP session processing section disconnect the SIP session.

Moreover, the present invention may be constituted in such a way that the control section in the aforementioned invention detects an ON operation of a session switching section composed of a switch, a button, or the like after the connection of the non-SIP information terminal device to the terminal interface section or the power turn-on is made to thereby make the SIP session processing section establish the SIP session, and detects an OFF operation of the switch, the button, or the like after the disconnection of the non-SIP information terminal device from the terminal interface section or the power turn-off is made to thereby make the SIP session processing section disconnect the SIP session.

Moreover, the present invention may be constituted in such a way that, in the aforementioned invention, the non-SIP information terminal device is a USB device, the USB device and the terminal interface section are connected by a USB cable, and the control section controls the SIP session processing section so as to automatically establish the SIP session with a communication partner which is set up by connecting the USB cable to the interface section or turning on the power of the USB device connected by the USB cable, and to automatically disconnect the established SIP session by pull-out of the USB cable or power turn-off of the USB device.

Moreover, the present invention may be constituted in such a way that in the aforementioned invention, the non-SIP information terminal device is a USB device, the USB device and the terminal interface section are connected by a USB cable, and upon receiving the non-SIP information from the USB device, the control section controls the SIP session processing section to automatically establish the SIP session with the communication partner triggered by the reception.

Moreover, the present invention may constitute the control section in the above-mentioned invention in such a way that the communication partner is changed for every type of the USB device according to device type identification information, such as a USB device class of the USB device to thereby controls the SIP session processing section to automatically establish the SIP session corresponding to each of them.

Moreover, the present invention may be constituted in such a way that in the above-mentioned invention, the device type identification information, such as the USB device class is stored in the USB device.

Moreover, the present invention may be constituted in such a way that in the above-mentioned invention, the non-SIP information terminal device and the terminal interface section are connected by a serial interface, and the control section controls the SIP session processing section so as to automatically establish the SIP session by receiving a call request from the non-SIP information terminal device, and to disconnect the established SIP session by reception of a disconnection notice from the non-SIP information terminal device.

Moreover, the present invention may also constituted in such a way that the control section in the aforementioned invention, when the call request from the non-SIP information terminal device is received, controls the SIP session processing section to automatically establish the SIP session for being a communication partner based on a telephone number received as a command.

Moreover, the present invention may constituted in such a way that the control section in the above-mentioned invention, after setting up a established destination of the SIP session to the SIP converter in advance, controls the SIP session processing section to automatically establish the SIP session without receiving the notice of the telephone number of the communication partner upon the call request from the non-SIP information terminal device.

Moreover, the present invention may constituted in such a way that the control section in the aforementioned invention monitors control signals of the serial interface to transmit a change of the control signal to a communication partner connected via the communication line by the SIP message.

Moreover, the present invention may be constituted in such a way that in the above-mentioned invention, after connecting the non-SIP information terminal device and the terminal interface section with an Ethernet (registered trademark), the control section controls the SIP session processing section so as to establish the SIP session by a TCP transfer permission request from the non-SIP information terminal device, and to disconnect the established SIP session by a TCP transfer termination request from the non-SIP information terminal device.

Moreover, the present invention can be constituted in such a way that in the above-mentioned invention, after connecting the non-SIP information terminal device and the terminal interface section with the Ethernet, the control section makes the data converting section convert the received non-SIP data from the non-SIP information terminal device into the SIP message by reception of a UDP frame from the non-SIP information terminal device to thereby transmit it to the communication partner connected via the communication line.

Moreover, the present invention may be constituted in such a way that the non-SIP information terminal device and the terminal interface section in the aforementioned invention are connected by a cable for contact detection, and the control section controls the SIP session processing section so as to perform establishment and disconnection of the SIP session based on contact information received from the non-SIP information terminal device via the cable for contact detection.

Further, the present invention can be constituted in such a way that the non-SIP information terminal device and the terminal interface section in the aforementioned invention are connected by a cable for contact detection, and the control section is controlled so as to monitor the contact information of the cable for contact detection to thereby transmit a change of the contact information to the communication partner connected via the communication line by the SIP message.

Hence, according to the present invention, even when the non-SIP information terminal devices, such as a telephone or the like other than an electronic camera, a personal computer, or an IP phone machine, are connected by the USB cable, the serial interface, the Ethernet, the cable for contact detection, or the like, the SIP converter can perform the establishment and disconnection of the SIP session, and the transmission of the SIP message on behalf of the non-SIP information terminal device to thereby perform management of communications of the non-SIP information terminal device by utilizing SIP.

### EFFECT OF THE INVENTION

According to the SIP converter device of the present invention, even when the non-SIP information terminal device is connected to the SIP converter, the SIP converter can perform the establishment and disconnection of the SIP session, and the transmission of the SIP message on behalf of the non-SIP information terminal device to thereby perform management of communications of the non-SIP information terminal device by utilizing SIP.

Details of one or more embodiments of the present invention are given by the attached drawings and the following description. Another objects and advantages of the present invention will become apparent from the following description, and the appended drawings and claims.

### BRIEF DESCRIPTION OF THE DRAWINGS

FIG. 1 is a view of a general system configuration when communications are performed by employing an embodiment of the present invention while connecting a non-SIP information terminal device to a SIP converter which is connected to communication lines via a line terminating device;

FIG. 2 is a function configuration view of the SIP converter shown in FIG. 1;

FIG. 3 is a sequence diagram showing a procedure to start communications when the non-SIP information terminal according to the embodiment in accordance with the present invention is connected as an interface using USB;

FIG. 4 is a sequence diagram showing a procedure to establish a session to thereby perform data communications in the case of receiving an SOF packet transmitted from the non-SIP information terminal device, when the SIP session according to the embodiment in accordance with the present invention is a USB device upon starting a USB transaction;

FIG. 5 is a sequence diagram showing a procedure to establish the session to thereby perform the data communication, when the SIP converter cannot recognize the SIP information terminal device according to the embodiment in accordance with the present invention as the USB device;

FIG. 6 is a sequence diagram showing a procedure to disconnect the SIP session established in FIG. 5;

FIG. 7 is a sequence diagram showing a procedure to start communications when the non-SIP information terminal according to the embodiment in accordance with the present invention is connected using a serial interface;

FIG. 8 is a sequence diagram showing a procedure to disconnect the SIP session established in FIG. 7;

FIG. 9 is a sequence diagram showing a procedure of an automatic calling operation by a direct call when a call procedure according to the embodiment in accordance with the present invention is V.25bis;

FIG. 10 is a sequence diagram showing a procedure for the SIP converter 3 to transmit the SIP message by only information that CS signals, ER signals, or the like have been changed, when the CS signals, the ER signals, or the like have been changed between the SIP converter 3 and the non-SIP information terminal device according to the embodiment in accordance with the present invention;

FIG. 11 is a sequence diagram showing a procedure to establish the session to thereby perform the data communications in the case where the interface of the non-SIP information terminal device 4 is an Ethernet, when TCP is used in PC or the like according to the embodiment in accordance with the present invention;

FIG. 12 is a sequence diagram showing a procedure to disconnect the SIP session established in FIG. 11;

FIG. 13 is a sequence diagram showing a procedure to establish the session to thereby perform the data communications in the case where the interface of the non-SIP information terminal device 4 is the Ethernet, when UDP is used in PC or the like according to the embodiment in accordance with the present invention;

FIG. 14 is a sequence diagram showing a procedure to establish the session to thereby perform the data communications by detecting contact information due to a switch or a button of the non-SIP information terminal device according to the embodiment in accordance with the present invention;

FIG. 15 is a sequence diagram showing a procedure to disconnect the SIP session established in FIG. 14;

FIG. 16 is a sequence diagram showing a procedure to establish the session to thereby perform the data communications, when the change of the contact information of the non-SIP information terminal device according to the embodiment in accordance with the present invention is converted into the SIP message to thereby transmit it to a communication partner connected by the communication line;

FIG. 17 is a sequence diagram showing a procedure to establish the session to thereby perform the data communications, when transmitting to a communication partner connected by the communication line using a SIP session switching section, such as a button, a switch, or the like on a side of the SIP converter triggered by the change of the contact information of the non-SIP information terminal device according to the embodiment in accordance with the present invention;

FIG. 18 is a sequence diagram showing a procedure to disconnect the SIP session established in FIG. 17.

### DETAILED DESCRIPTION

Preferred embodiments according to the present invention will be described in more details with reference to the attached drawings hereinafter.

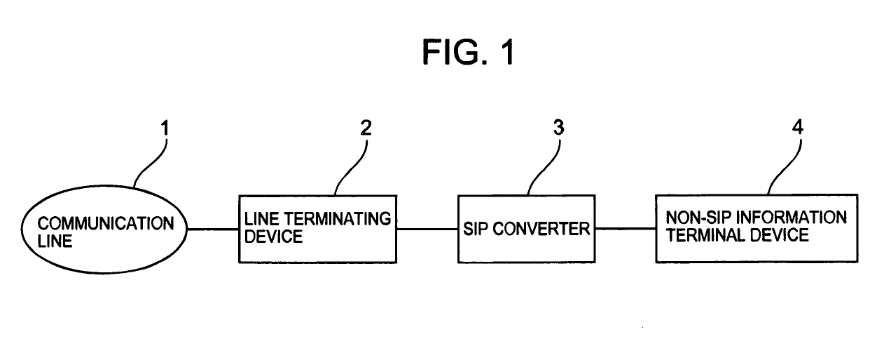

FIG. 1 is a view of a general system configuration when communications are performed by employing the embodiment in accordance with the present invention while connecting a non-SIP information terminal device to a SIP converter which is connected to communication lines via a line terminating device.

According to FIG. 1, a communication line 1 and a SIP converter 3 are connected via a line terminating device 2, and a non-SIP information terminal device 4 in which SIP is not supported is connected to the SIP converter 3 by an interface, for example, a USB cable, a serial cable, an Ethernet cable, a cable for contact detection, or the like.

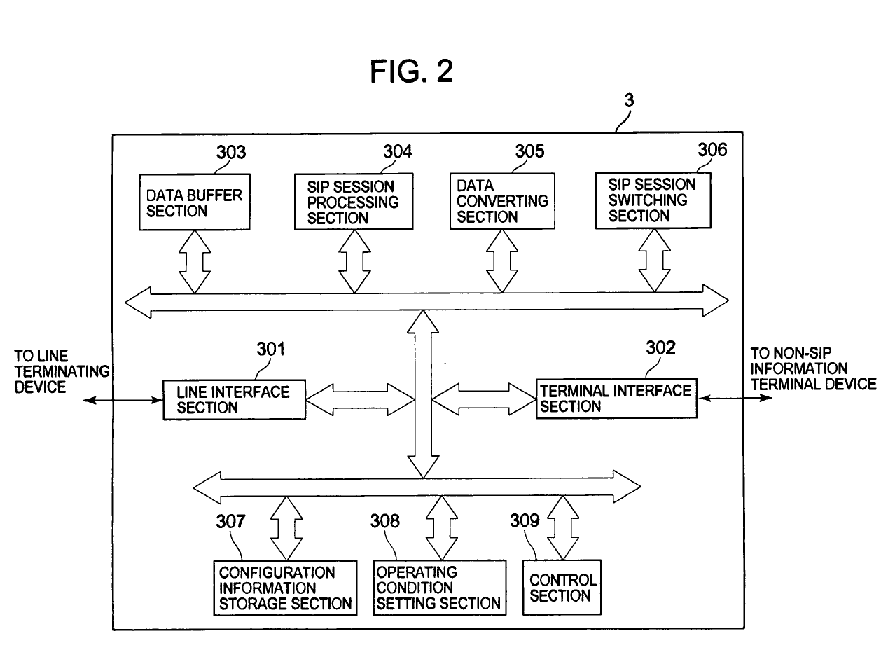

FIG. 2 is a function configuration view of the SIP converter 3.

According to FIG. 2 the SIP converter 3 is provided with a line interface section 301, a terminal interface section 302, a data buffer section 303, a SIP session processing section 304, a data converting section 305, a SIP session switching section 306, a configuration information storage section 307, an operating condition setting section 308, and a control section 309.

The line interface section 301 controls connection and disconnection of the communication line 1 and has a function to transmit and receive data.

The terminal interface section 302 transmits and receives date with the non-SIP information terminal device 4, and has a function to monitor a control signal line of the interface.

The data buffer section 303 has a function to temporarily store received data from the non-SIP information terminal device 4, and received data from a communication partner connected in the communication line 1.

The SIP session processing section 304 has a function to establish and disconnect an SIP session, and to transmit SIP messages with the communication partner connected by the communication line 1. A case where it establishes and disconnects the SIP session automatically and transmits the SIP message by a trigger from the non-SIP information terminal device 4, and a case where it establishes and disconnects the SIP and transmits the SIP message by depressing a switch or a button of the SIP session switching section 306 are considered.

The data converting section 305 has a function to generate the SIP message, and to convert between the non-SIP information on a side of the non-SIP information terminal device 4, and the SIP message on a side of the communication line 1.

The SIP session switching section 306 has a function of a switch or a button used as a trigger of establishment and disconnection of the SIP session and transmission of the SIP message.

The configuration information storage section 307 has a function to store an established destination and establishment conditions, and disconnection conditions of the SIP session and a transmission destination and transmission conditions of the SIP message, which are set up.

The operating condition setting section 308 has a function to set up the SIP session established destination, the establishment conditions, or the like stored in the configuration information storage section 307 by the user side, and it is constituted by a switch, a key, or the like.

The control section 309 has a function to control operations of the line interface section 301, the terminal interface section 302, the data buffer section 303, the SIP session processing section 304, the data converting section 305, the SIP session switching section 306, the configuration information storage section 307, and the operating condition setting section 308.

Next, the operation of the SIP converter 3 when the non-SIP information terminal device 4 performs data communications with a communication partner connected by the communication line 1 while utilizing the SIP will be described.

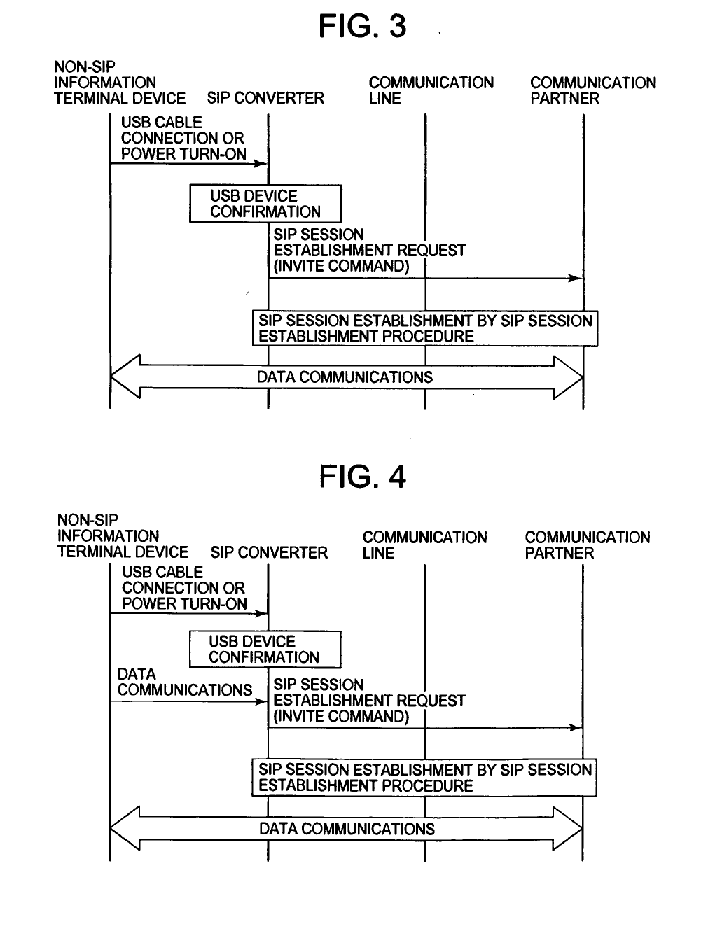

First, procedures to start a communication when the non-SIP information terminal device 4 is a personal computer, a camera, or the like and is connected using USB as an interface will be described using FIG. 3.

Namely, when the non-SIP information terminal device 4 is connected to the SIP converter 3 with a USB cable, or power of the non-SIP information terminal device 4 is turned on in a state where they are connected with the USB cable, the terminal interface section 302 of the SIP converter 3 recognizes the non-SIP information terminal device 4 as a USB device.

When the non-SIP information terminal device 4 is recognized as the USB device as described above, the SIP session processing section 304 automatically transmits an SIP session establishment request (INVITE command) to a communication partner which is set up by the operating condition setting section 308 and is stored in the configuration information storage section 307 via the communication line 1 to thereby establish a SIP session.

Subsequently, the non-SIP information terminal device 4 can perform the data communications with the communication partner.

As a result of this, even when the non-SIP information terminal device 4 is connected to the SIP converter 3 in the state where they are connected with the USB cable, or only by turning on the power of the non-SIP information terminal device 4 in the state where they are connected with the USB cable, the SIP converter 3 performs establishment control of the SIP session on behalf of the non-SIP information terminal device 4, thus allowing the non-SIP information terminal device 4 to perform communications with the communication partner via the communication line 1.

Next, a case of establishing the session in receiving a SOF packet transmitted from the non-SIP information terminal device 4 when the SIP session is the USB device upon starting a USB transaction will be described using FIG. 4.

Namely, data received by the terminal interface section 302 are once stored in the data buffer section 303, and if it is determined to be the SOF packet, the SIP session will be established by the SIP session processing section 304 in a manner similar to that described above, so that the non-SIP information terminal device 4 can perform the data communications with the communication partner via the communication line 1.

In such a configuration, even when the non-SIP information terminal device 4 is always connected via the USB cable, if data transfer is not always performed, the SIP session can be used efficiently by establishing the SIP session by reception of the SOF packet.

The established destination of the SIP session can perform the data communications with communication partners different for every USB device, such as recognized USB device name and USB device class (type), an audio, a printer or the like utilizing SIP, various services can be achieved by cooperating with high order applications.

Meanwhile, mainly in the case of a storage device, the established destination of the SIP session can be changed according to file types stored in the connected USB device, and when there are a plurality of data types, it is also possible to establish the SIP session for those. As a result of this, the data communications with different communication partners utilizing SIP are possible for every file type, such as JPEG (Joint Photographic Experts Group) file, MPEG2 (Moving Picture Experts Group Phase 2) file, MP3 (MPEG Audio Layer-3) file, or the like only by connecting the USB cable or turning on the power of the non-SIP information terminal device 4 in the state of connecting the USB cable, and thus allowing various services to be achievable by connecting a digital camera, a digital video camera, a portable audio player, or the like to the SIP converter 3.

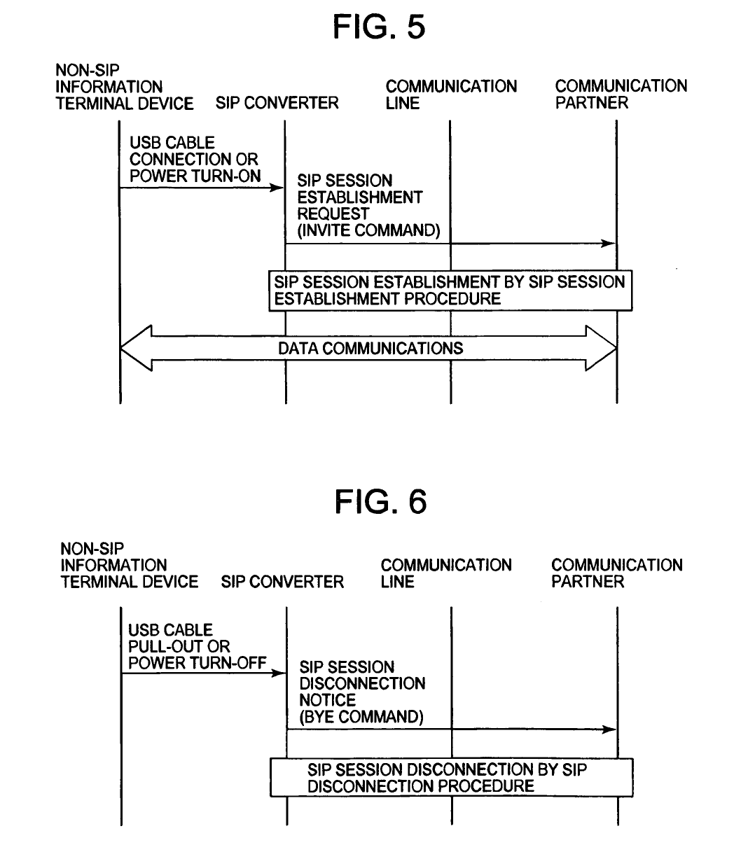

Next, a procedure in which such an apparatus is connected as the non-SIP information terminal device 4 and cannot be recognize as the USB device in the SIP converter 3 when the SIP information terminal device (USB device) 4 is not a commonly used device but a new device which has not been used until now will be described using FIG. 5.

According to FIG. 5, even when the non-SIP information terminal device 4 is not recognized as the USB device at the SIP converter 3 side, the terminal interface section 302 recognizes it as the USB device based on the information that the non-SIP information terminal device 4 is connected, without waiting for recognition that it is the USB device, and the SIP session processing section 304 automatically transmits an SIP session establishment request (INVITE command) to a communication partner which is set up by the operating condition setting section 308 and is stored in the configuration information storage section 307 to thereby establish a SIP session. Subsequently, the non-SIP information terminal device 4 will perform the data communications with the communication partner via the communication line 1.

When the SIP session established as described above is disconnected, the SIP session processing section 304 automatically transmits a disconnection notice (BYE command) to a communication partner at the SIP session established destination via the communication line 1 triggered by the terminal interface section 302 pulling out the USB cable or detecting power turning-off of the non-SIP information terminal device 4 as shown in FIG. 6, and the SIP session will be disconnected.

Further, while there are a system in which a telephone number of a communication partner is transmitted as a command upon a call request (address call) and a system in which a telephone number of a communication partner is set up in advance to thereby originate a call to the telephone number set up by a call request (direct call) in a call procedure to the communication partner, the present invention is applicable in any cases.

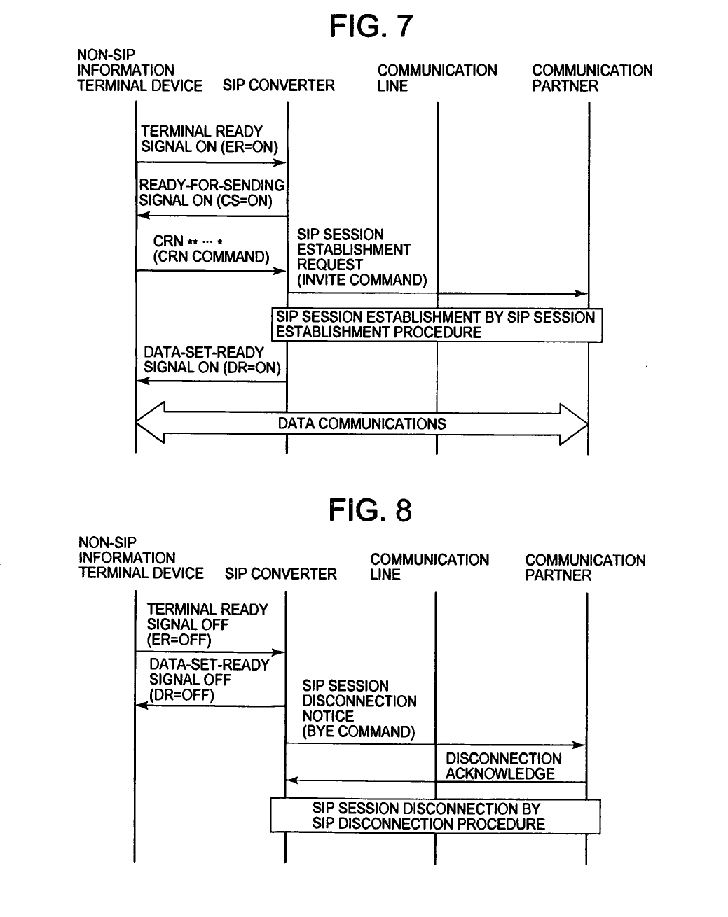

Namely, first, the non-SIP information terminal device 4 is a serial interface in FIG. 7, and a procedure to start a communication when the address call system is employed will be described.

When the non-SIP information terminal device 4 is the serial interface, V.25bis, AT command, or the like is generally used as the call procedure, but the fundamental operation of the SIP converter 3 is the same.

In this case, since the non-SIP information terminal device 4 turns on a terminal ready signal (ER) in transmitting data, the SIP converter 3 returns a ready-for-sending signal (CS) in response to this to the non-SIP information terminal device 4 (CS=ON).

As a result of this, since a telephone number is sent as a CRN command of “CRN**..*” from the non-SIP information terminal device 4 side, the SIP session processing section 304 automatically transmits an SIP session establishment request (INVITE command) to a communication partner which is set up by the operating condition setting section 308 and is stored in the configuration information storage section 307, and the SIP session is established.

The terminal interface section 302 changes a data-ready signal (DR) to ON after the SIP session establishment, and thus the non-SIP information terminal device 4 can perform the data communications with a communication partner via the communication line 1.

After the data communications, a procedure to complete the data communications is performed in such a way that a disconnect request of a terminal ready signal OFF (ER=OFF) is transmitted from the non-SIP information terminal device 4 as shown in FIG. 8, and in response to this, the SIP converter 3 transmits a data-set-ready signal OFF (DR=OFF) to the non-SIP information terminal device 4 and the SIP session processing section 304 automatically transmits the “BYE command” as the disconnection notice of the SIP session to a communication partner via the communication line 1, so that the SIP session will be disconnected.

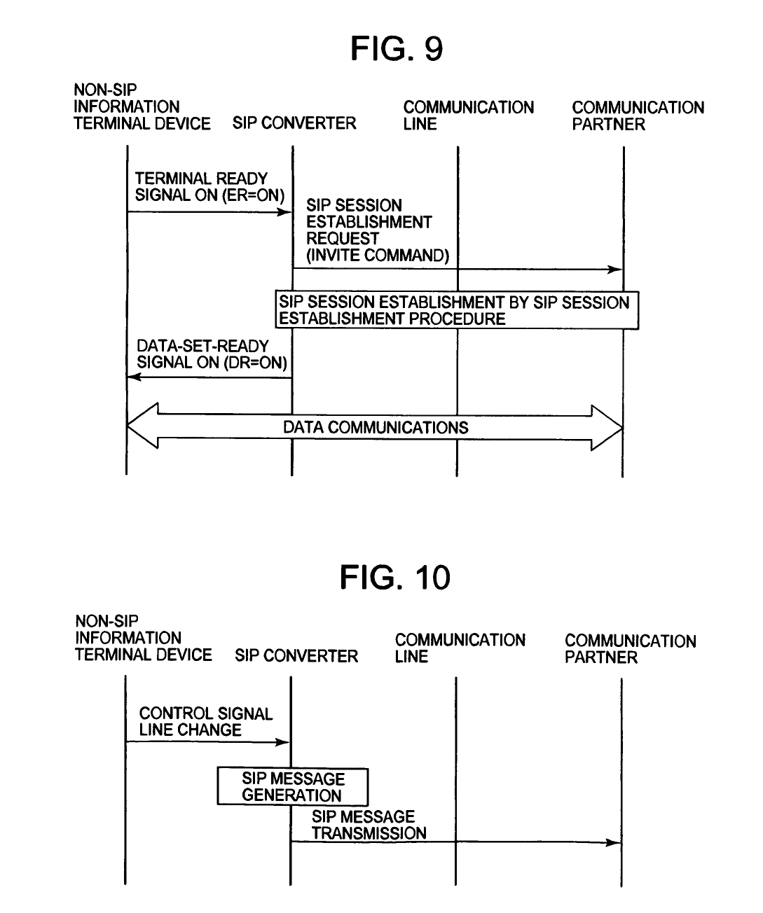

Next, an automatic calling operation based on the direct call when the call procedure is V.25bis will be described using FIG. 9.

In FIG. 9, the non-SIP information terminal device 4 changes the terminal ready signal (ER) from OFF to ON upon starting a data communication. When the terminal interface section 302 detects a terminal ready signal (ER) ON, the SIP session processing section 304 automatically transmits the SIP session establishment request (INVITE command) to a communication partner which is set up by the operating condition setting section 308 in advance and is stored in the configuration information storage section 307 to thereby establish a SIP session.

After the SIP session is established as described above, the terminal interface section 302 changes the data-set-ready signal (DR) to ON, and when the non-SIP information terminal device 4 detects this data-set-ready signal (DR), the non-SIP information terminal device 4 can perform the data communications with the communication partner via the communication line 1.

After the data communications, a procedure to complete the data communications is the same as that of the case of the address call shown in FIG. 8, and thus detailed description thereof will be omitted.

Next, in the case where the CS signal, the ER signal, or the like changes between the SIP converter 3 and the non-SIP information terminal device 4 in FIG. 10, a procedure for the SIP converter 3 to transmit the SIP message based on only information that it has changed will be described.

Namely, while it is what the SIP converter 3 generates the SIP message by the call request from the non-SIP information terminal device 4 and automatically transmits the establishment request (INVITE command) of the SIP session to a communication partner connected by the communication line 1 to thereby establish the SIP session, that makes it possible for the terminal interface section 302 of the SIP converter 3 to detect a state change of the control signal line which the non-SIP information terminal device 4 transmits to thereby transmit it to the set communication partner as the SIP message.

As a result, even when the non-SIP information terminal device 4 supports only, for example, half-duplex communications, the data communications utilizing SIP can be performed. When performing communications while opposing to a non-SIP information terminal device which supports only the half-duplex communications, the non-SIP information terminal device can transmit data by receiving transmission permission from an opposite device. In a configuration of the present invention, the SIP converter 3 monitors a signal line of the non-SIP information terminal device 4 to transmit information that the ready-for-sending signal has been changed to the opposite device as the SIP message, so that the non-SIP information terminal device which is a communication partner can transmit the data.

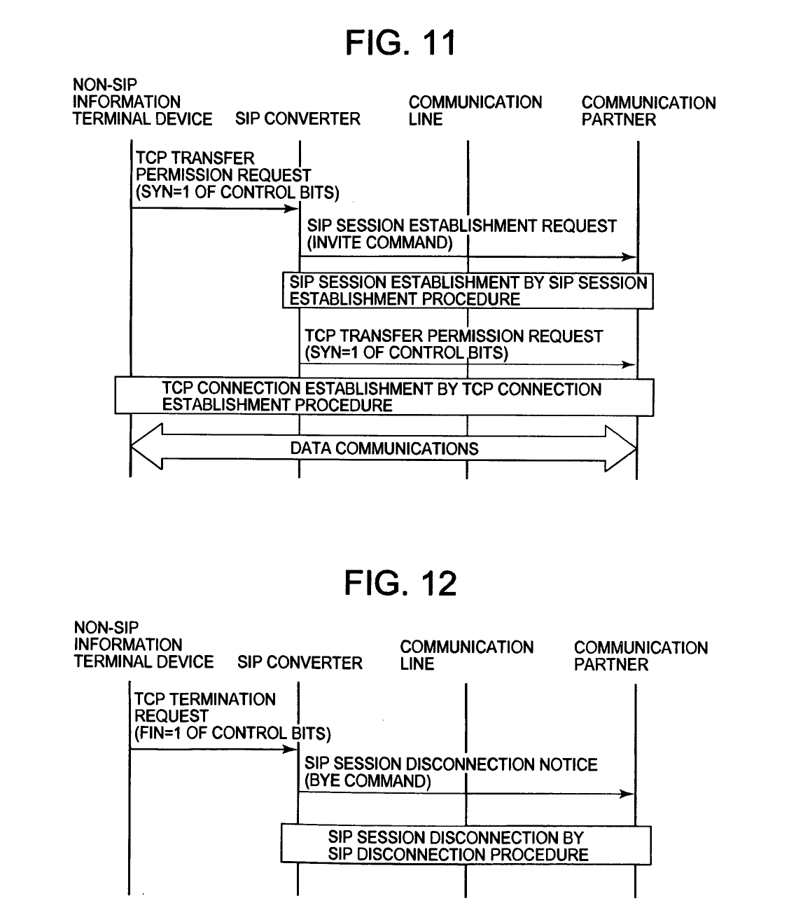

Next, when PC uses TCP in FIG. 11, a procedure for the interface of the non-SIP information terminal device 4 to establish a session in the case of an Ethernet to thereby perform the data communications will be described.

Namely, when the data communications are started in the non-SIP information terminal device 4, if the terminal interface section 302 receives an IP frame from the non-SIP information terminal device 4, it stores the IP frame in the data buffer section 303 and distinguishes whether an upper layer (layer 4) is TCP (Transmission Control Protocol) or UDP (User Datagram Protocol) by an IP header of a received frame.

When the layer 4 is TCP, if SYN (transfer permission request) of control bits of a TCP frame is valid, the SIP session processing section 304 automatically transmits the SIP session establishment request (INVITE command) to a communication partner stored in the configuration information storage section 307 via the communication line 1 to thereby establish a SIP session.

Subsequently, a TCP connection will be established and the non-SIP information terminal device 4 can perform the data communications with the communication partner.

In completing the data communications, when the data communications are performed by TCP shown in FIG. 11, the SIP session processing section 304 automatically transmits the disconnection notice (BYE command) to the communication partner by receiving a frame in which FIN (disconnect request) of the control bits of the TCP frame is valid from the non-SIP information terminal device 4 and executes a disconnection of the SIP session as shown in FIG. 12.

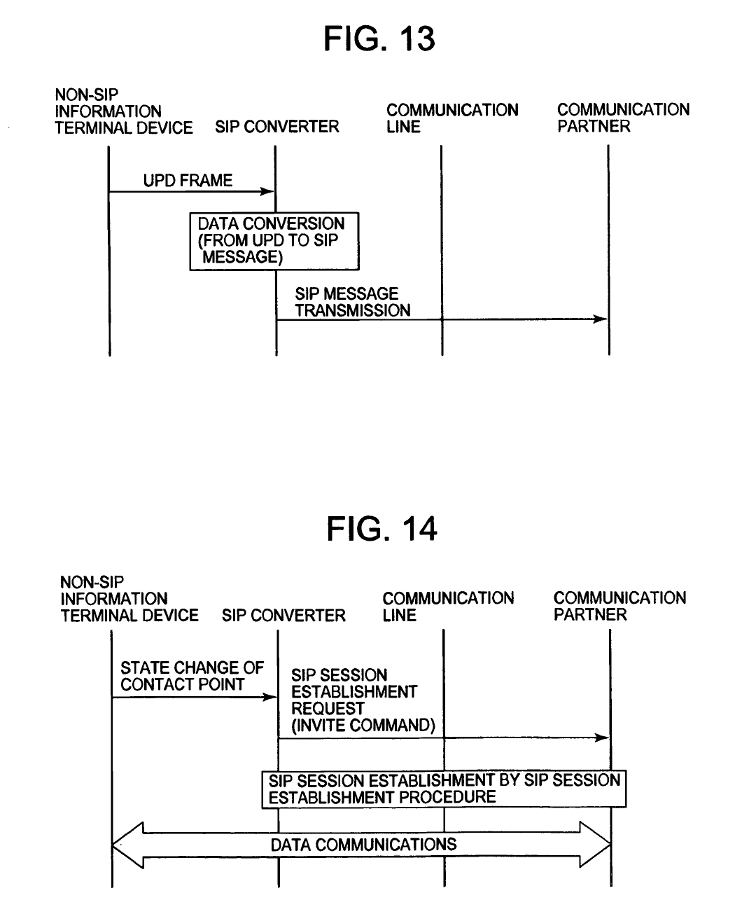

Next, when PC uses UDP in FIG. 13, a procedure to establish a session to thereby perform the data communications in the case where the interface of the non-SIP information terminal device 4 is an Ethernet will be described.

Namely, in starting the data communications in the non-SIP information terminal device 4, when the terminal interface section 302 receives a UDP frame from the non-SIP information terminal device 4, it stores the UDP frame in the data buffer section 303, the data converting section 305 converts the UDP frame stored in the data buffer section 303 into the SIP message, the SIP session processing section 304 automatically transmits the SIP message to a communication partner stored in the configuration information storage section 307 via the communication line 1, and the non-SIP information terminal device 4 can perform the data communications with the communication partner.

In the case of UDP shown in FIG. 12, since it is only the data transfer by the SIP message, the SIP session has not been established, and the disconnection of the SIP session is not required, either.

Moreover, the SIP converter 3 in the present invention may be constituted in such a way that establishment and disconnection of the SIP session may be performed by contact information (change of a contact state, such as a voltage change due to turn-on of a power switch or the like) received from the non-SIP information terminal device 4.

Namely, a procedure to perform the data communications by detecting the contact information due to a switch or a button of the non-SIP information terminal device 4 to thereby establish the session in FIG. 14 will be first described.

Namely, when the terminal interface section 302 detects the contact information of the non-SIP information terminal device 4, the SIP session processing section 304 automatically transmits the SIP session establishment request (INVITE command) to a communication partner stored in the configuration information storage section 307 triggered by the detection of this contact information to thereby establish the SIP session, and subsequently, the non-SIP information terminal device 4 can perform the data communications with the communication partner.

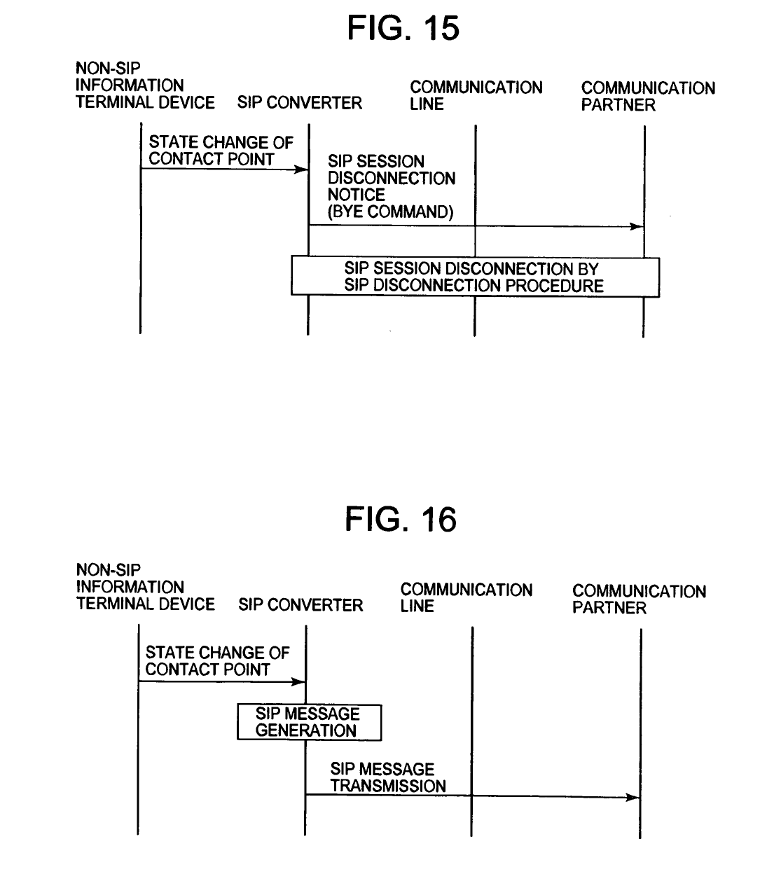

In completing the data communications, the SIP session processing section 304 automatically transmits the SIP session disconnection notice (BYE command) to the communication partner using the state change of the contact point (a case of turning off the power switch or the like) as the contact information to thereby execute the disconnection of the SIP session as shown in FIG. 15.

As a result of this, the SIP session is established triggered by the contact information received from the non-SIP information terminal device 4, and various services cooperating with high order applications, such as performing the data communications with the interface of USB or the like can be achieved.

A service in which, for example, the SIP converter 3 which has received the contact information from a monitoring device utilizing an infrared sensor which is a non-SIP information terminal device establishes the SIP session with a security company to transfer the information on the camera connected with the USB interface to the security company, so that the security company can find illegal entry, may also be utilized.

Moreover, it is also possible to convert a change in the contact information into the SIP message to transmit it to the communication partner connected by the communication line 1 without establishing the SIP session as shown in FIG. 16.

If the above-described example is employed, the SIP converter 3 which has received the contact information from the monitoring device utilizing the infrared sensor which is the non-SIP information terminal device transmits the SIP message to the security company, so that the security company can find illegal entry.

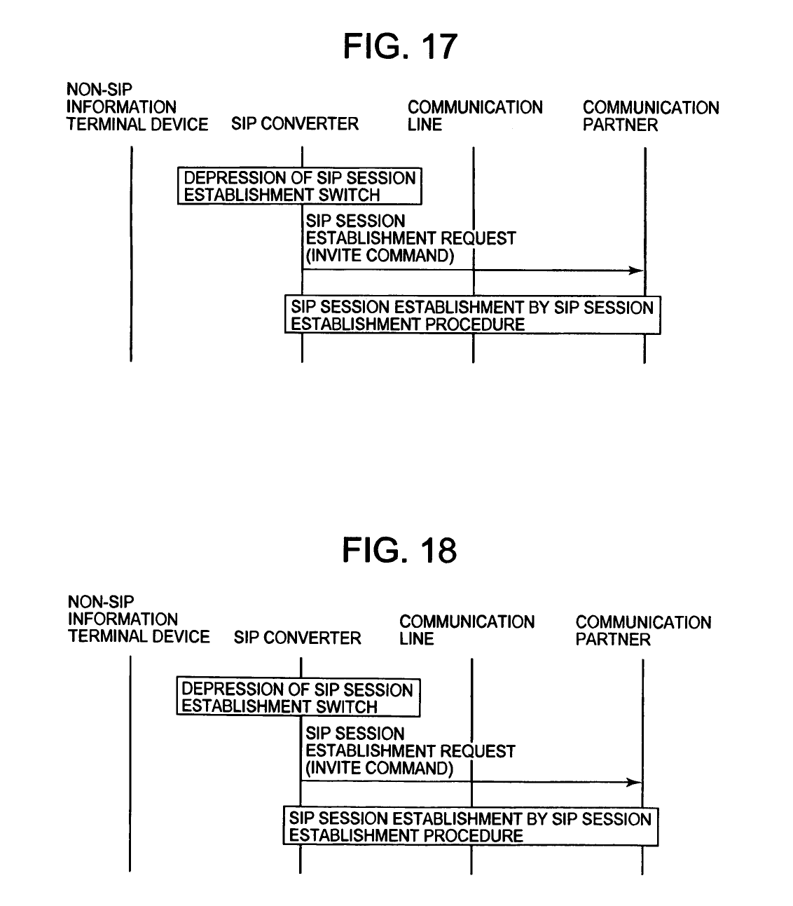

Moreover, although it is assumed in the embodiment described above, but not limited to this, that the SIP session establishment and disconnection procedure, and the SIP message transmission procedure automatically perform the data communications triggered by the state change of the non-SIP information terminal device 4, the SIP converter 3 itself is provided with the SIP session switching section 306, such as a button and a switch (refer to FIG. 2) as shown in FIG. 17, for example, and transmits the SIP session establishment request (INVITE command) to a communication partner stored in the configuration information storage section 307 by turning on the operation of the SIP session switching section 306 (depress the button or the switch), so that the non-SIP information terminal device 4 can perform the data communications with the communication partner.

Accordingly, it is possible to constitute so as to transmit the SIP session disconnection notice by the OFF operation (depression of the button or the switch) of the SIP session switching section 306 as shown in FIG. 18.

Moreover, the communication between the SIP converter and the communication partner in the present embodiment is all performed utilizing SIP, resulting in easy management of a communication history. Hence, when charging to users for communication services, it is easily possible to employ a charging system to charge for the SIP session establishment time from the connection to the disconnection of the SIP session. In the case of the SIP message, the number of SIP messages transmitted and received or the like can be charged for.

While the specific preferred embodiments of the present invention have been described in full detail, it will be understood that various changes and modifications may be made therein without departing from the true spirit and scope of the present invention.

### INDUSTRIAL APPLICABILITY

Even when the non-SIP information terminal device is connected to the SIP converter, the SIP converter can perform the establishment and disconnection of the SIP session, and the transmission of the SIP message on behalf of the non-SIP information terminal device, and thus the present invention will be applicable to the SIP converter or the like, which enables to perform management of communications of the non-SIP information terminal by utilizing SIP when the non-SIP information terminal device in which SIP is not supported is connected via the communication line.

1. A SIP converter connected to a communication line, wherein when communications are performed by connecting a non-SIP information terminal device, the SIP converter performs establishment and disconnection of a SIP session, and transmission of a SIP message on behalf of the non-SIP information terminal device.

2. The SIP converter according to claim 1, comprising
a terminal interface section for transmitting and receiving data with the non-SIP information terminal device;
a SIP session processing section for performing establishment and disconnection of the SIP session, and transmission of the SIP message with a communication partner connected via the communication line;
a data converting section for generating the SIP message and performing a conversion between the non-SIP information of the non-SIP information terminal device and the SIP message; and
a control section for controlling the terminal interface section, the data converting section, and the SIP session control section.

3. The SIP converter according to claim 2, wherein the control section detects a connection of the non-SIP information terminal device to the terminal interface section, or a power turn-on thereof to thereby make the SIP session processing section establish the SIP session, and detects a disconnection of the non-SIP information terminal device from the terminal interface section, or a power turn-off thereof to thereby make the SIP session processing section disconnect the SIP session.

4. The SIP converter according to claim 2, wherein the control section detects an ON operation of a session switching section composed of a switch, a button, or the like after the connection of the non-SIP information terminal device to the terminal interface section or the power turn-on is made to thereby make the SIP session processing section establish the SIP session, and detects an OFF operation of the switch, the button, or the like after the disconnection of the non-SIP information terminal device from the terminal interface section or the power turn-off is made to thereby make the SIP session processing section disconnect the SIP session.

5. The SIP converter according to claim 2, wherein the non-SIP information terminal device is a USB device, and the control section controls the SIP session processing section so as to automatically establish the SIP session with a communication partner which is set up by turning on the power of the USB device connected, and to disconnect the established SIP session by power turn-off of the USB device.

6. The SIP converter according to claim 2, wherein the non-SIP information terminal device and the terminal interface section are connected by a serial interface, and the control section controls the SIP session processing section so as to establish the SIP session by receiving a call request from the non-SIP information terminal device, and to disconnect the established SIP session by reception of a disconnection notice from the non-SIP information terminal device.

7. The SIP converter according to claim 2, wherein the control section controls the SIP session processing section so as to establish the SIP session by a TCP transfer permission request from the non-SIP information terminal device, and to disconnect the established SIP session by a TCP transfer termination request from the non-SIP information terminal device.

8. The SIP converter according to claim 2, wherein the control section makes the data converting section convert the received non-SIP data from the non-SIP information terminal device into the SIP message by reception of a UDP frame from the non-SIP information terminal device, and transmits it to a communication partner connected via the communication line.

9. The SIP converter according to claim 2, wherein the control section controls the SIP session processing section so as to perform establishment or disconnection of the SIP session based on contact information received from the non-SIP information terminal device.

10. The SIP converter according to claim 9, wherein the control section monitors the contact information to transmit a change of the contact information to the communication partner connected via the communication line by the SIP message.
